(19) United States
(12) Patent Application Publication
(10) Pub. No.: US 2014/0117878 A1
(43) Pub. Date: May 1, 2014

(54) MERGED-STAGE HIGH EFFICIENCY HIGH POWER FACTOR HB-LED DRIVER WITHOUT ELECTROLYTIC CAPACITOR

(71) Applicant: EXAR CORPORATION, Fremont, CA (US)

(72) Inventors: ALEKSANDER PRODIC, Toronto (CA); MOR PERETZ, Be'er Sheva (IL)

(73) Assignee: EXAR CORPORATION, Fremont, CA (US)

(21) Appl. No.: 13/894,725

(22) Filed: May 15, 2013

Related U.S. Application Data
(60) Provisional application No. 61/647,158, filed on May 15, 2012.

(51) Int. Cl. H05B 33/08

(52) U.S. Cl. CPC H05B 33/0815
USPC 315/307

(57) ABSTRACT

The present application relates to boost-resonant converter for driving high brightness LEDs (HB LED) that incorporates power factor correction (PFC) and does not require a bulky electrolytic capacitor. The new converter incorporates the PFC and the LED supplies into a single stage. The system allows a large voltage ripple across the intermediate energy storage capacitor reducing its value. Constant light output and dimming capability are obtained by variable frequency current control of the resonant converter. A high power factor is achieved by DCM boost front-end portion with controlled average output voltage. The converter is regulated by a digital controller that implements a variable-frequency variable duty ratio algorithm. Experimental results with a 15 W prototype verify near unity power factor operation, above 88% efficiency and constant lamp current over the entire operating range.

### CLAIM OF PRIORITY

This application claims priority from the following co-pending application, which is hereby incorporated in its entirety: U.S. Provisional Application No. 61/647,158 entitled: “MERGED-STAGE HIGH EFFICIENCY HIGH POWER FACTOR HB-LED DRIVER WITHOUT ELECTROLYTIC CAPACITOR”, by Aleksandar Prodic, et al., filed May 15, 2012.

### FIELD OF THE INVENTION

The present application relates to drivers for Light Emitting Diodes (LEDs).

### BACKGROUND

High-Brightness Light Emitting Diodes (HB LEDs) are becoming widely accepted because of their superior longevity, maintenance requirements and high luminance. To supply these devices, cost-effective and reliable solutions are highly desirable.

One of the main drawbacks of the present day utility line-fed HB LED drivers is the presence electrolytic capacitors. Electrolytic capacitors reduce the reliability and also increase the size and cost of the driver. Existing HB LED lighting supply systems are single-stage solutions that provide high power factor and lamp current. These conventional single-stage drivers, e.g. flyback, boost or sepic converters have electrolytic output capacitor that eliminates flickering of the light at twice the line frequency. Two-stage solutions minimize the capacitor value and volume requirements, but the savings come at the cost of a significant increase in part count and controller complexity.

### SUMMARY

Embodiments of the present invention include a merged-stage boost-resonant converter Light Emitting Diode (LED) driver that uses a large voltage ripple on the resonant stage input. This design can avoid bulky electrolytic capacitors with only one additional switch and a low current while still obtaining a high power factor, high efficiency, and eliminating low frequency flickering.

A merged-stage boost-resonant LED driver can be controlled using a single switch portion. A boost portion is positioned before the switch portion. The boost portion producing a boost voltage. A resonant converter portion is positioned after the switch portion. The resonant converter portion used to provide current to a LED. A digital controller is adapted to monitor the boost voltage and current to the LED and adjust the duty ratio and frequency of the switches of the switch portion so as to control both the boost voltage and the current to the LED.

### BRIEF DESCRIPTION OF THE DRAWINGS

FIG. 1 shows an exemplary single-stage boost resonant HB-LED driver of one embodiment.

FIG. 2 shows a normalized impedance and current as a function of the drive frequency for a series resonant network of one embodiment.

FIG. 3 shows simulation results of typical performance waveforms of the boost-resonant converter.

FIG. 4 shows simulation results of balanced lamp current asymmetrical control operation.

FIG. 5 shows an exemplary digital gating generation for pulse-frequency pulse-width modulator (PF-PWM).

FIG. 6 shows regulation capability of the output current of the converter under large bus voltage ripples variations. For FIG. 6, lamp current is (I_{LED}, 5 A/div), Lamp voltage is (V_{LED}, 20V/div), Drain-Source voltage of Q2 is (V_{Q2}_{_{—}}_{DS}, 50V/div) Horizontal scale is 5 ms/div.

FIG. 7 shows balanced lamp current under asymmetrical control operation and ZVS operation of the power transistors. For FIG. 7, lamp current is (L_{ED}, 5 A/div), Lamp voltage is (V_{LED}, 20V/div), Drain-Source voltage of Q2 is (V_{Q2}_{_{—}}_{DS}, 50V/div). Horizontal scale is 2 μs/div.

FIG. 8 shows experimental results for one embodiment with performance of full power (15 W) at high line input voltage of 110 Vrms. For FIG. 8, lamp current is (I_{LED}, 5 A/div), Input line voltage is (Vₗᵢₙₑ, 50V/div), Input line current is (Iₗᵢₙₑ, 50 mA/div). Horizontal scale is 5 ms/div.

FIG. 9 shows performance in full power (15 W) at low high input voltage of 110 Vrms. For FIG. 9, lamp current is (I_{LED}, 5 A/div), Input line voltage is (Vₗᵢₙₑ, 50V/div), Input line current is (Iₗᵢₙₑ, 50 mA/div). Horizontal scale is 5 ms/div.

FIG. 10 shows performance in full power (15 W) at low line input voltage of 90 Vrms. For FIG. 10, lamp current is (I_{LED}, 5 A/div), Input line voltage is (Vₗᵢₙₑ, 50V/div), Input line current is (Iₗᵢₙₑ, 50 mA/div). Horizontal scale is 5 ms/div.

FIG. 11 shows performance under dimming in half power (7.7 W) at high line input voltage of 90 Vrms. For FIG. 11, lamp current is (I_{LED}, 5 A/div), Input line voltage is (Vₗᵢₙₑ, 50V/div), Input line current is (Iₗᵢₙₑ, 50 mA/div). Horizontal scale is 5 ms/div.

### DETAILED DESCRIPTION

A merged-stage boost-resonant light-emitting diode (LED) driver 100 comprises a switch portion 102; a boost portion 104 before the switch portion 102; and a resonant converter portion 106 after the switch portion; the resonant converter portion providing current to a LED. A digital controller 108 is connected to control the switch portion 102. The digital controller 108 monitoring a bus voltage before the switch portion 102 to select a duty ratio and monitors a LED related current after the switch portion 102 to select a switching frequency.

In one embodiment, the digital controller 108 provides two outputs for a pair of switches 102a and 102b in the switch portion.

The bus voltage is the voltage across a boost capacitor 110. The boost capacitor 110 can be selected to be a relatively small capacitor that is not an electrolytic capacitor. This avoids the issues of cost and leakage involved with electrolytic capacitor.

The resonant converter portion 105 includes an inductor 112 and capacitor 114. The resonant converter portion 106 is connected to a LED 118 through a transformer 120. The LED related current can be the current at the resonant converter portion side the transformer 120.

The boost portion 104 includes a boost inductor 116. An input rectifier 122 is connected to the boost portion 104.

Details of one embodiment are described below.

The switch portion 102 can be a half-bridge switch assembly with switches (Q1 102a, Q2 102b) driving a series resonant network (Lr 112, Cr 114). The switching components 102 are shared between the front and output portions of the converter. In this case, the switches 102a and 102b are also used by the boost (input) portion 104 of the converter, where the boost inductor 116 is connected between the fullwave input rectifier 122 and the middle point of the half-bridge. The load (HB-LED string 118) is connected in series to the resonant tank via a transformer 120 that allows amplitude adjustment and isolation. The load configuration that was chosen is an anti-parallel connection of LEDs that allows direct drive of high frequency ac current without rectification. By the natural properties of a series resonant network, the resonant current (which passes through the load) has zero dc offset, which means that the current balancing between the positive and negative parts is inherent in the design.

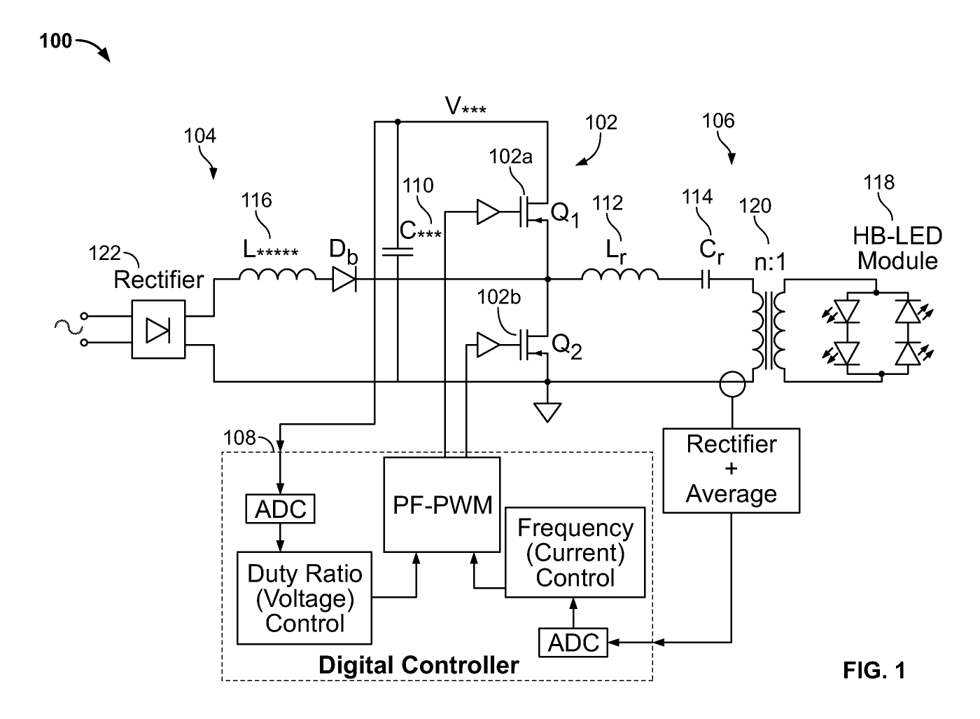

The converter of FIG. 1 operates with variable duty ratio variable-frequency control. To control the output resonant portion of the converter the variable frequency above the series resonant frequency (fr=½π\sqrt{LᵣCᵣ}) is used, to assure Zero Voltage Switches (ZVS). The operation of the boost is regulated through duty ratio variation. In this way, both the resonant and boost parts can be controlled relatively independently while sharing the same switches. In the system of FIG. 1 the frequency and duty ratio control signals are created with two separate compensators and fed to a digital controller novel digital block pulse-frequency pulse-width modulator (PF-PWM), which creates variable-frequency variable duty ratio pulses.

The boost converter 100 operates in Digital Control Mode (DCM) to assure relatively high power factor at its input side with simple circuitry. The boost output voltage ripple is allowed to have large variations; and therefore, a low value output capacitor 110 can be used. The capacitor voltage V_{bus} is regulated with a slow controller such that its average, i.e. dc, value remains constant and the large ripple is not affected.

The role of the resonant part is to drive the LEDs by a constant average current to avoid low frequency light flickering under large voltage variations in the input. Therefore, the resonant current is sensed and regulated by the average current programmed mode control that varies the drive frequency of the converter. In other words, the resonant circuit operates such that a portion of the difference between the time-varying input power and the dc average output power is provided by the resonant tank, easing requirements for the energy storage capacitor.

The resonant impedance and current as a function of the drive frequency can be expressed as:

$$\begin{matrix}\vert Z ( j Ω ) \vert = \sqrt{{Q}^{2} + {( Ω - \frac{1}{Ω} )}^{2}} & ( 1 ) \\ \vert {i}_{s} ( j Ω ) \vert = {V}_{in} / \sqrt{{Q}^{2} + {( Ω - \frac{1}{Ω} )}^{2}} & ( 2 )\end{matrix}$$

where Q is the network's quality factor, Ω=f/fᵣ is the deviation of the drive frequency from the resonant frequency and Vᵢₙ is the normalized input voltage.

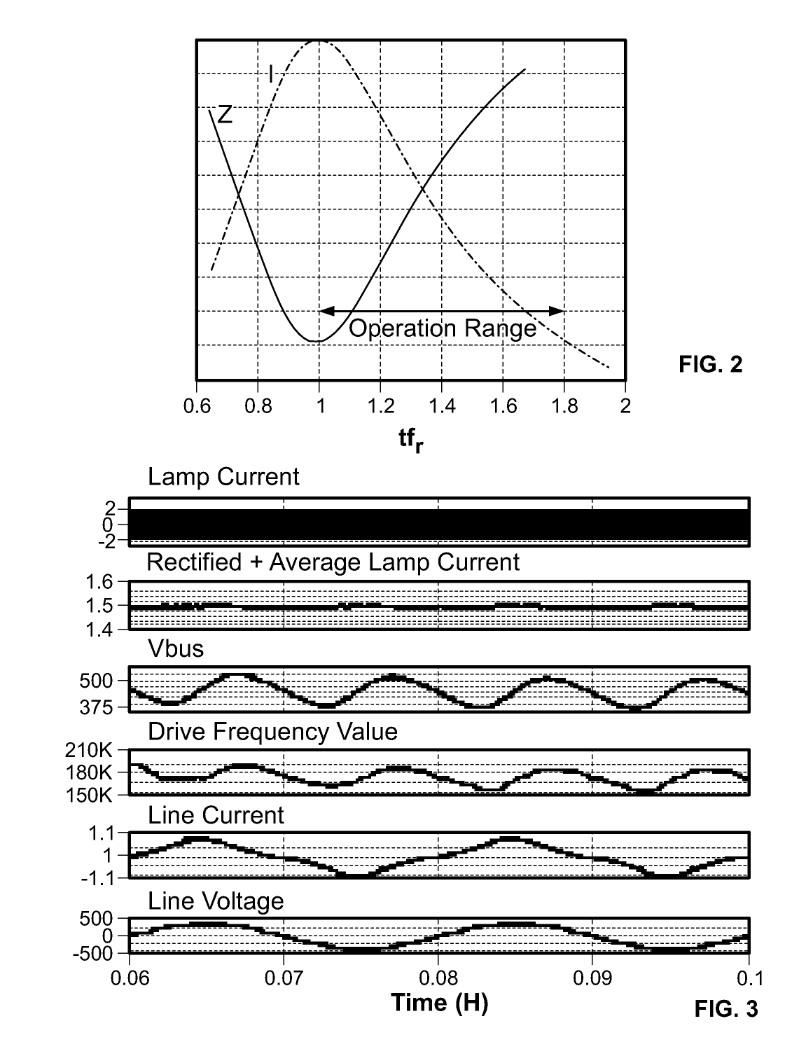

FIG. 2 shows the frequency characteristic of equations (1) and (2). It implies that in order to maintain constant current, the drive frequency of the converter should increase when the input voltage is high and decrease for low inputs. To achieve this, the control loop needs to be fast enough to compensate for the capacitor ripple, since the input voltage to the resonant converter in this case has large variations. It should be noted that the current loop also provides dimming capability, since the current reference can be set to the desired value.

FIG. 3 depicts typical waveforms of the frequency control operation for a specific operating point (lamp current value) for several line cycles. It shows the change of drive frequency with the input bus variation and maintains constant average lamp current; that is, no light flickering. Since the operating point is constant, the average value of the bus voltage remains constant and therefore the duty ratio is fixed. Thus the boost converter operates in DCM and provides high power factor seen from the input.3

A challenge in the design of the power driver is to properly interface the boost stage to the resonant converter stage, more precisely, to avoid bus voltage runaway under light load conditions. The runaway effect can be described as follows: the dc conversion ratio of the boost operating in DCM can be expressed by:

$$\frac{{V}_{bus}}{{V}_{in}} = \frac{1}{2} ( 1 + \sqrt{1 + \frac{2 {D}_{on}^{2} \vert {Z}_{L} ( {f}_{s} ) \vert}{{L}_{boost} {f}_{s}}} ) \qquad ( 3 )$$

where Vᵢₙ is the input voltage, V_{bus} is the output voltage of the boost converter, |Z_{L}(fₛ)| is the equivalent impedance magnitude of the resonant network at a given operation frequency (fₛ), L_{boost} is the boost inductor value, and Dₒₙ is the duty ratio.

Assuming now, that Dₒₙ is constant and the frequency controller is attempting to reduce the output current of the resonant converter. These results in an increased drive frequency and, consequently, increased impedance seen by the boost. As it can be seen from (3) the increased impedance may cause the output voltage to increase and the frequency control will attempt to further increase the frequency. This creates a runaway effect of the bus voltage that may damage the system. To avoid this problem, the bus voltage controller is implemented.

Another design consideration is a proper selection of the inductors to guarantee ZVS for a wide operation range of the output current (dimming conditions). Similar to a conventional resonant converter, the ZVS condition for Q2 depends on the resonant inductor value (Lr) and the current value at the commutation instance (Ir_comm). The energy condition can be expressed by:

$$\frac{{C}_{par\_Q 2} {V}_{bus}^{2}}{2} = \frac{{L}_{r} {I}_{r\_comm}^{2}}{2} \qquad ( 4 )$$

where Cₚₐᵣ_{_{—}}_{Q2} is the drain source equivalent parasitic capacitance of Q2.

On the other hand, ZVS condition for Q1 depends on the boost inductance (L_{boost}) and on its current value (I_{boost}_{_{—}}_{comm}) at the commutation point. To find the ZVS condition the following energy expression can be used:

$$\frac{{C}_{par\_q 1} {V}_{bus}^{2}}{2} = \frac{{L}_{boost} {I}_{boost\_comm}^{2}}{2} \qquad ( 5 )$$

where Cpar_Q1 is the drain source equivalent parasitic capacitance of Q1.

To guarantee ZVS conditions for the entire operation range, the selection procedure should take into account the minimum current value when the LEDs are dimmed and the highest instantaneous bus voltage that is allowed.

For a single anti-parallel configuration of cascaded LEDs, current balancing even under asymmetrical drive conditions is guaranteed. A property of the resonant converter is to keep zero dc current offset; hence each side of the anti-parallel connection of the LEDs conducts the same amount of current.

Further details of the design considerations, such as current balancing for multiple parallel strings, bus capacitor selection, and current sensing and circuit optimization will be given in the full paper.

The controller of this converter changes the drive frequency at a high rate, to accommodate the large voltage variations of the bus voltage around the dc value. At the same time, it also varies the duty ratio slowly, to regulate the dc value of the bus voltage and achieve close to unity power factor. This means that a variable-frequency with constant absolute duty ratio control is required. For that purpose, a novel digitally controlled high-resolution pulse frequency pulse-width modulator (PF-PWM) of FIG. 1 is developed, which is the key functional element of the controller.

A simplified block diagram of the modulator is shown in FIG. 5. The modulator receives information about the absolute value of the duty ratio (not the on-time of the transistor) from the voltage loop. Then, based on the required switching period, which is set by the compensator of the resonant converter, adjusts the on-time accordingly. In this way constant duty ratio is maintained for variable frequency. To convert the absolute duty ratio value into appropriate on-time without sacrificing time and frequency resolution a dedicated block, named Don-Ton converter, was developed. A refine current Iref is also used to control the LED dimming.

A prototype of the HB LED driver was designed and built according to the schematic of FIG. 1. The parameters of the experimental unit were: Input voltage: 110 Vᵣₘₛ; Output load: 2×4.5 V@1.6 A high brightness white LEDs at each anti-parallel side; Frequency range: 90 kHz-300 kHz. The component values that were used: Boost inductor: 500 μH@0.2 Arms; Resonant inductor: 300 μH@1Arms; Bus capacitor: 2 μuF@400 VDC (thick film); Resonant capacitor: 10 nF@630V(polypropylene); Transformer: 4:1, E16 3F3. The digital controller that was used for current control scheme and the bus voltage control were realized on Altera FPGA (CycloneII 2C35). It should be noted that the bus capacitor value used is 2 μF, which enables the use of a non-electrolytic capacitor.

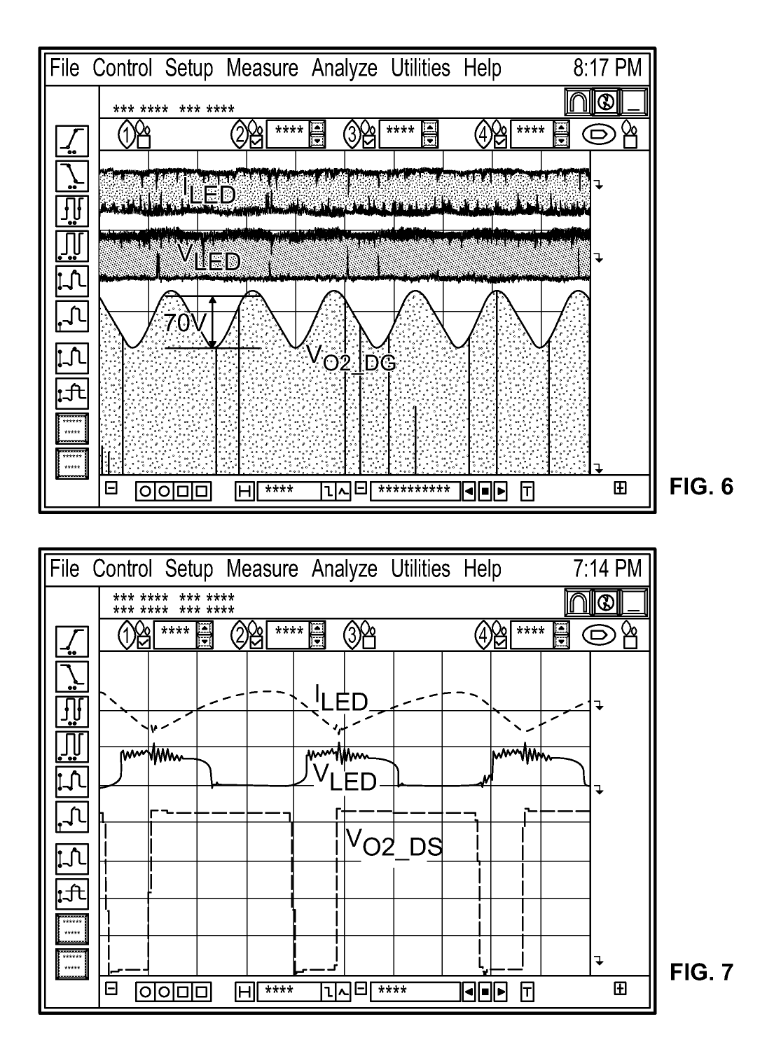

The experimental results confirm high efficiency and a good power factor. Performance of the converter was evaluated for two dimming cases, nominal power (15 W) and about half power (7.7 W). The measured efficiency was 90% and 88%, respectively. FIGS. 6 and 7 verify functionality of the system. FIG. 6 shows the lamp current and the drain-source voltage of Q2 as well as the large voltage ripple that is allowed. FIG. 7 shows a zoomed-in display of the lamp current, lamp voltage, and Q2 drain voltage, depicting ZVS operation of the converter and the current balancing (50% conduction of each LED while Don=20%).

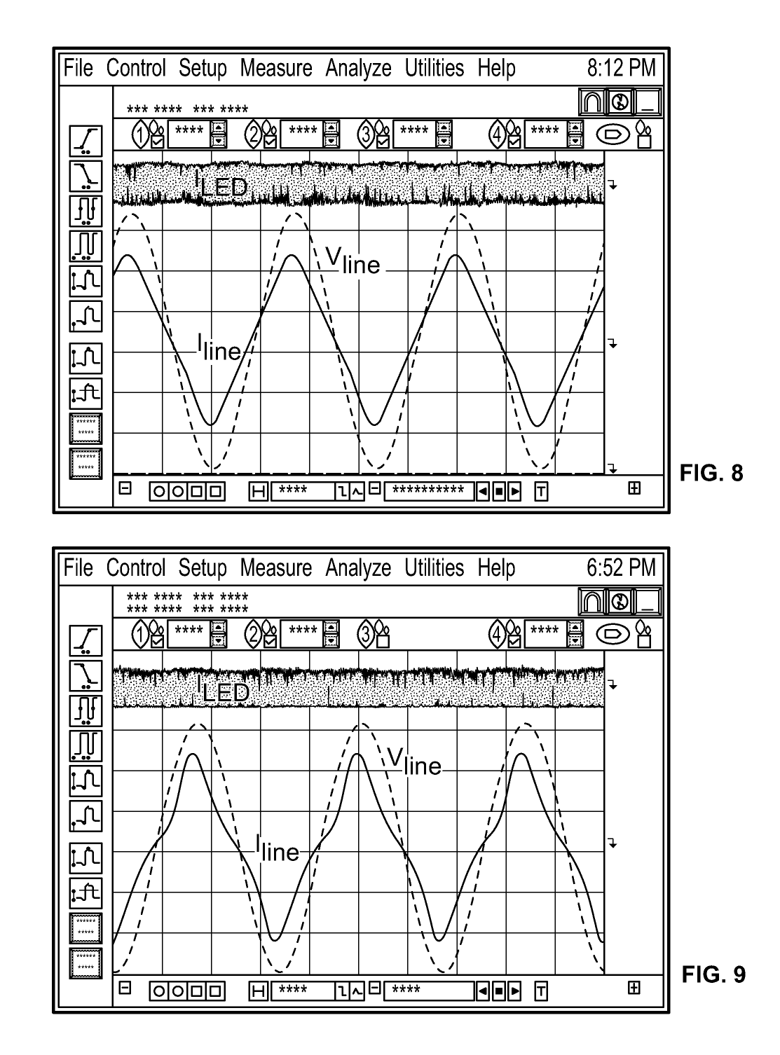

FIGS. 8 and 9 depict performance of the converter operating at 110 Vrms under full load and 50% dimming conditions, demonstrating near unity power factor while the LEDs current envelope is constant.

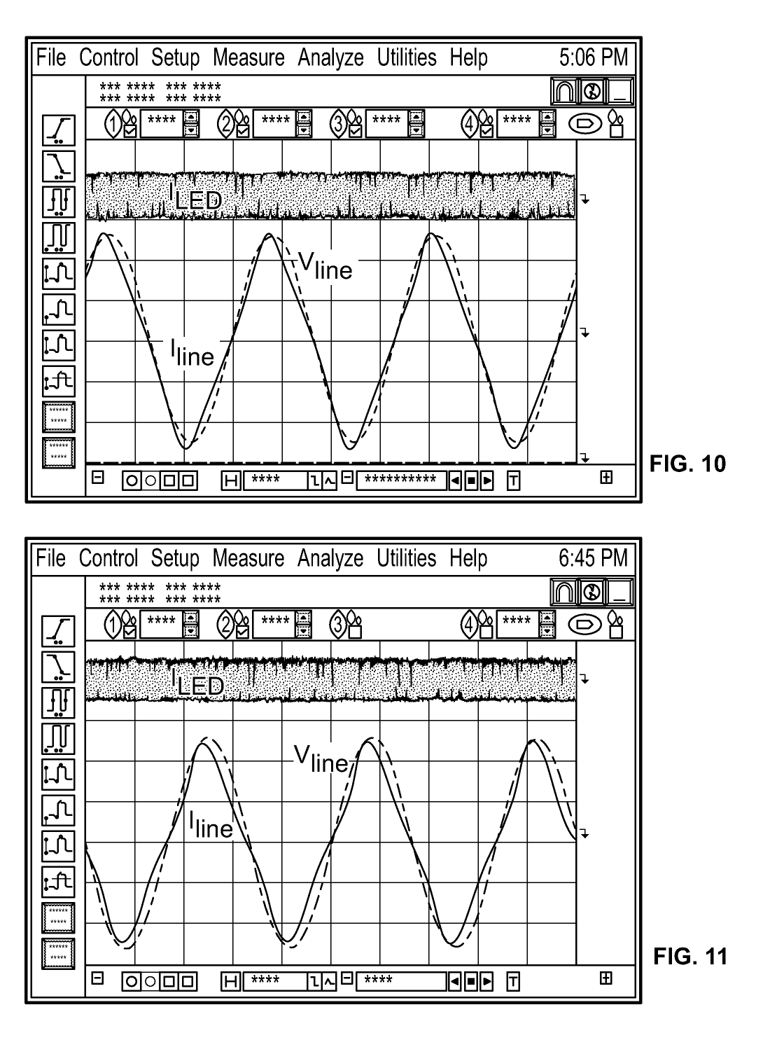

FIGS. 10 and 11 show operation of the driver for low line (90 Vrms).

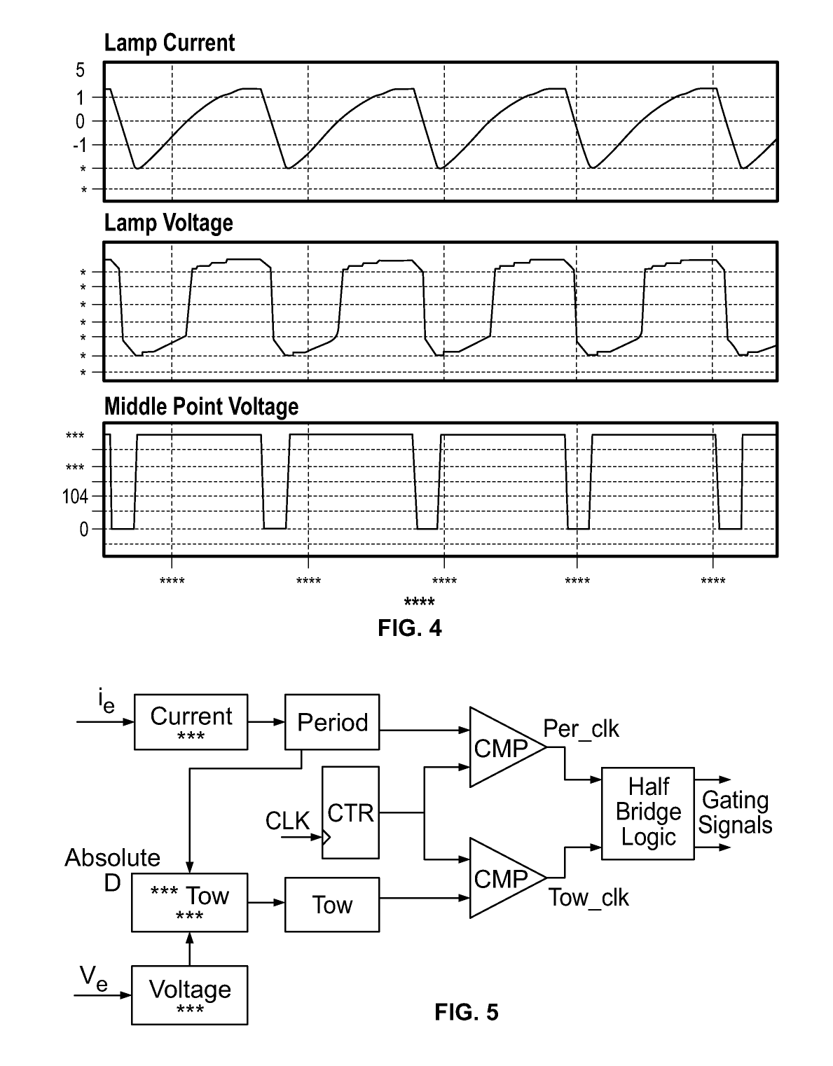

The crest factors (Vpk/Vrms) of the LEDs current (FIG. 4 and FIG. 10) were calculated to be 1.6 for the triangular part (during the time Q2 conducts) and 1.45 for the resonant part (during the “on” time of Q1).

A single-stage boost-resonant converter is introduced as an HB-LED driver with PFC rectification. The power driver is designed such that the energy storage capacitor ripple is allowed to have large deviations; hence, the bulky electrolytic capacitor can be eliminated. The current of the LEDs is regulated by variable frequency control of the resonant circuit to facilitate constant average current while the input voltage varies. Output current balancing is guaranteed by the properties of the resonant converter that dictates zero dc offset. The front-end portion of the power driver that is connected to the utility grid employs a boost converter operating in DCM to achieve high power factor operation. To avoid voltage runaway in light load conditions, the output voltage of the boost converter (input of the resonant converter) is regulated by duty ratio control. A simple, efficient, digital control algorithm was developed to carry out the current and voltage control tasks for both stages, through variable-frequency variable duty ratio control. Design guidelines for obtaining ZVS under all operating conditions are given. High efficiency and high power factor were experimentally verified for different line and load conditions.

The foregoing description of preferred embodiments of the present invention has been provided for the purposes of illustration and description. It is not intended to be exhaustive or to limit the invention to the precise forms disclosed. Many embodiments were chosen and described in order to best explain the principles of the invention and its practical application, thereby enabling others skilled in the art to understand the invention for various embodiments and with various modifications that are suited to the particular use contemplated. It is intended that the scope of the invention be defined by the claims and their equivalents.

1. A merged-stage boost-resonant light-emitting diode (LED) driver comprising:
a switch portion;
a boost portion before the switch portion;
a resonant converter portion after the switch portion, the resonant converter portion providing current to a LED; and
a digital controller connected to control the switch portion, the digital controller monitoring a bus voltage before the switch portion to select a duty ratio and monitoring a LED related current after the switch portion to select a frequency.

2. The LED driver of claim 1, wherein the digital controller provides two outputs for a pair of switches in the switch portion.

3. The LED driver of claim 1, wherein the bus voltage is the voltage across a boost capacitor.

4. The LED driver of claim 3, wherein the boost capacitor is not an electrolytic capacitor.

5. The LED driver of claim 1, further comprising the LED.

6. The LED driver of claim 1, wherein the resonant converter portion includes an inductor and capacitor.

7. The LED driver of claim 1, wherein the boost portion includes a boost inductor.

8. The LED driver of claim 1, wherein the resonant converter portion is connected to a LED through a transformer.

9. The LED driver of claim 1, wherein LED related current is the current at the resonant converter portion side the transformer

10. The LED driver of claim 1, wherein a rectifier is connected to the boost portion.

11. A digital controller for a light-emitting diode (LED) driver, the digital controller controlling a switch portion in a LED driver, the digital controller monitoring a bus voltage before the switch portion and a LED related current after the switch portion as feedback to control the switching of the switch portion.

12. The digital controller for a light-emitting diode (LED) driver of claim 11, wherein the digital controller provides two outputs for a pair of switches in the switch portion.

13. The digital controller for a light-emitting diode (LED) driver of claim 11, wherein the bus voltage is the voltage across a boost capacitor.

14. The digital controller for a light-emitting diode (LED) driver of claim 13, wherein the boost capacitor is not an electrolytic capacitor.
